(19) United States
(12) Patent Application Publication
(10) Pub. No.: US 2021/0253863 A1
(43) Pub. Date: Aug. 19, 2021

(54) ARTICLE INCLUDING PHTHALOCYANINE DYES

(71) Applicant: VIAVI SOLUTIONS INC., San Jose, CA (US)

(72) Inventors: Jaroslaw ZIEBA, Santa Rosa, CA (US); Kangning LIANG, Santa Rosa, CA (US)

(73) Assignee: VIAVI SOLUTIONS INC., San Jose, CA (US)

(21) Appl. No.: 17/308,555

(22) Filed: May 5, 2021

Related U.S. Application Data
(63) Continuation of application No. 16/230,451, filed on Dec. 21, 2018.

(51) Int. Cl. C09B 47/22; C09B 47/24; C09B 47/28; C09B 47/30; G02F 1/01

(52) U.S. Cl. CPC C09B 47/22; C09B 47/24; C09B 47/28; G03H 1/0011; G02F 1/0136; G02F 2202/04; C09B 47/30

(57) ABSTRACT

An article, includes a selective light modulator layer including a phthalocyanine dye having substituents that provide a bathochromic shift or a hypsochromic shift in the absorption spectrum. A method of making an article is also disclosed.

### FIELD OF THE INVENTION

The present disclosure generally relates to articles, such as optical devices in the form of foil, sheets, and/or flakes. The optical device can include a selective light modulator layer including a phthalocyanine dye having substituents that provide a bathochromic shift or a hypsochromic shift in the absorption spectrum. Methods of making the optical devices are also disclosed.

### BACKGROUND OF THE INVENTION

Dyes are regularly used in decorative applications. However, their use is limited because they are not able to withstand extended exposure to actinic irradiation similar to that present outdoors under intense solar illumination. Additional factors, such as elevated humidity levels and the presence of oxygen, also contribute to the limited stability of dyes.

What is needed is a dye that can be used in various applications, including decorative, automotive, and cosmetic, that can exhibit at least one of the following properties: visual color, light-fastness, solubility, aggregation, and stability. The dye can control visual and non-visual performance attributes when used in various applications.

### SUMMARY OF THE INVENTION

In an aspect, there is disclosed an article including a selective light modulator layer including a phthalocyanine dye having substituents that provide a bathochromic shift or a hypsochromic shift in the absorption spectrum.

In another aspect, there is disclosed an article including a selective light modulator layer including a phthalocyanine dye with at least one of substituents that provide a bathochromic shift, substituents that provide a hypsochromic shift, a central metal ion that shifts the absorption spectrum of the phthalocyanine dye, an off-plane ligand to a central metal ion, an alpha substituent, and a beta substituent.

Additional features and advantages of various embodiments will be set forth, in part, in the description that follows, and will, in part, be apparent from the description, or can be learned by the practice of various embodiments. The objectives and other advantages of various embodiments will be realized and attained by means of the elements and combinations particularly pointed out in the description herein.

### DETAILED DESCRIPTION OF THE INVENTION

It is to be understood that both the foregoing general description and the following detailed description are exemplary and explanatory only, and are intended to provide an explanation of various embodiments of the present teachings. In its broad and varied embodiments, disclosed herein are articles, such as optical devices, for example, in the form of foils, sheets, and flakes; and a method of manufacturing the article. The article can include a dye that can be designed to control at least one of the following properties: visual color, light-fastness, solubility in select media, aggregation, and solvatochromy. The design of the dye can include selecting and/or altering at least one of the following: electronic structure, functional side groups, central metal atoms, and axial ligands. In an aspect, the article can include a selective light modulator layer including a phthalocyanine dye having substituents that provide a bathochromic shift or a hypsochromic shift in the absorption spectrum. In another aspect, the article can include a selective light modulator layer including a phthalocyanine dye with at least one of substituents that provide a bathochromic shift, substituents that provide a hypsochromic shift, a central metal ion that shifts the absorption spectrum of the phthalocyanine dye, an off-plane ligand to a central metal ion, an alpha substituent, and a beta substituent.

It is envisioned that the phthalocyanine dye can be designed by the selection of its substituents to provide at least one of the properties discussed above. The phthalocyanine dye can be included in a selective light modulator layer of an article. Because the phthalocyanine dye can be tailored to achieve a particular property it can be present in the article in smaller amounts while still producing the desired property. This can result in a material cost saving and a thinner selective light modulator layer

In an aspect, the article can be in a form of a sheet that can be used on an object or a substrate. In another aspect, the article can be in a form of a foil or flake. For example, the article can have a lamellar shape. In an aspect, the article can be an optical device. In another aspect, a composition can include the article and a liquid medium, such as a carrier. The composition can be an ink, a varnish, a paint, etc. In another aspect, the article is an optical device in the form of a flake, for example having 100 nm to 100 μm in thickness and 100 nm to 1 mm in size. The article can be a color shifting colorant, or can be used as a security feature for currency.

The dye for use in the disclosed article can be designed to achieve particular properties favorable for decorative, cosmetic, and/or automotive applications. In particular, the dye can be a phthalocyanine dye. The chemical structure of a phthalocyanine dye can be used as a base compound because it provides high values of molar extinction coefficients, which is a measure of how strongly a chemical species attenuates light at a given wavelength. The molar extinction coefficient of a compound can be calculated using Beer-Lambert Law A=εcl, wherein A is the absorbance of the sample, ε is the molar extinction coefficient of the material, c is the molar concentration of those species, and l is the light path length (cm). In an aspect, the article can include a phthalocyanine dye having a molar extinction coefficient ranging from about 1×10⁴ M⁻¹cm⁻¹ to about 5×10⁵ M⁻¹cm⁻¹, for example greater than or equal to about 1×10⁵ M⁻¹cm⁻¹ at the Q-Band maximum absorption. The phthalocyanine dyes having the disclosed molar extinction coefficient can exhibit saturated colors. The phthalocyanine dyes can be included in a thinner layer, as compared to a layer without the disclosed phthalocyanine dyes, and still achieve a vibrant color at a cheaper manufacturing cost. In an aspect, the phthalocyanine dye can be present in a layer in an amount ranging from about 5×10⁻⁴ mol/l to about 10 mol/l.

The phthalocyanine dye can have an aromatic macrocyclic ring exhibiting strong thermal stability. The phthalocyanine dye can have eight alpha and 8 beta peripheral hydrogens that can be substituted. Typically, an unsubstituted phthalocyanine dye can absorb strongly between 600 nm to 700 nm to yield a green or blue color. By selecting the type and location of various substituents, the Q-bands can be shifted to obtain a red or a blue color.

Depending on the chemical nature of the substituents, substitutions on the macrocyclic ring can donate electrons to the ring, which would enhance delocalization of the pi-electrons on the ring. For example, the phthalocyanine dye can include substituents that provide a bathochromic shift, i.e., a red shift in the ultraviolet to visible absorption spectrum, such as electron donating groups. The bathochromic shift of absorption of Q-bands can impart a red color of the phthalocyanine dye. Non-limiting examples of a substituent that is an electron donating group include alkyl, aryl, alkoxy, aryloxy, OH, amides, esters, and thiols. A hydrocarbon portion in these substituents can be linear or branched; primary, secondary, or tertiary; cyclic or acyclic; aromatic or nonaromatic. The electron donating group can include a methyl, methoxy, isopropyloxy, tert-butoxy, phenyl, biphenyl, acetyloxy, isopropylmercapto, phenylmercapto, acetamino, etc.,

Depending on the chemical nature of the substituents, substitutions on the macrocyclic ring can withdraw electrons from the ring, which would reduce delocalization of the pi-electrons on the ring. For example, the phthalocyanine dye can include substituents that provide a hypsochromic shift, i.e., a blue shift in the ultraviolet to visible absorption spectrum, such as an electron withdrawing group. The phthalocyanine dye can include substituents that introduce electron withdrawing functional groups. Non-limiting examples of a substituent that is an electron withdrawing group include pyrazine, fluoro, nitro, fluoroalkyl such as trifluoromethyl, organic ammonium, pyridinium, sulfonyl, cyano, carbonyl —C(O)R′, wherein R′ can be an alkyl or aryl, and ester —C(O)O R″, wherein R″ can be an alkyl, aryl, and the like.

The phthalocyanine dye can have a central metal ion. The central metal ion can increase the oxidative stability of the phthalocyanine dye in the presence of singlet oxygen. The central metal ion can reduce sensitizing triplet oxygen to form singlet oxygen. The central metal ion can be a paramagnetic ion. Non-limiting examples of paramagnetic ions include chromium (II), chromium (III), manganese (II), iron (III), iron (II), cobalt (II), cobalt (III), nickel (II), copper (II), and gadolinium (III). The paramagnetic ion can be selected from the group consisting of Cu(II), Co(II), V(IV)O, Mn(III), and Mo(IV)O.

The central metal ion can also shift the absorption spectrum of a phthalocyanine dye. A metal-free alpha-butoxy phthalocyanine absorbs light at 745 nm as compared to the Q-band of an alpha-butoxy phthalocyanine with a V(IV)O central metal ion that absorbs light at 770 nm. Additionally, the Q-band of an alpha-butoxy phthalocyanine with a Mn(III) central metal ion absorbs light at 825 nm.

In an aspect, the phthalocyanine dye can have a central non-metal element.

The phthalocyanine dye can have an off-plane (axial) ligand to a central metal ion. The off-plane ligand can restrict access of singlet and/or triplet oxygen to the macrocyclic ring. The off-plane ligand can include acyloxy and alkoxy groups.

The off-plane ligand can also subdue aggregation. Aggregation of phthalocyanine dyes can alter the following properties: absorption spectrum, solubility, and photostability.

As discussed herein, the phthalocyanine dyes can include multiple alpha and beta hydrogens, any one of which can be substituted. In an aspect, the phthalocyanine dye can include at least one alpha substituent. The at least one alpha substituent can disrupt aggregation. The at least one alpha substituent can be selected from the group consisting of alkoxy, alkyl, aryl, and thioether. For example, the at least one alpha substituent can be selected from the group consisting of alkoxy (2-ethylhexyloxy), alkyl (isopropyl, butyl, t-butyl, 2-ethylhexyl), aryl, and thioether.

Substitution at an alpha hydrogen can exert a bathochromic shift. An unsubstituted phthalocyanine (PcH2) absorbs at 664 nm, whereas the Q-band of alpha-butoxy substituted phthalocyanine ((alpha-BuO)8PcH2) absorbs at 769 nm.

In another aspect, the phthalocyanine dye can include at least one beta substituent. The at least one beta substituent can tune the color of the compound and/or enhance photostability of the compound. The at least one beta substituent can be selected from the group consisting of alkoxy, alkyl, aryl, and thioether.

Substitution at a beta hydrogen can also exert a bathochromic shift. An unsubstituted phthalocyanine (PcH2) absorbs at 664 nm, whereas the Q-band of beta-isopropylmercapto substituted phthalocyanine ((beta-S-iPr)8PcH2) absorbs at 714 nm. Substitution at a beta hydrogen also results in improved lightfastness. For example, paint samples made from beta-tert-butylphenyl substituted phthalocyanine dyes ((beta-t-BuPh)4PcCu) and (beta-S-iPr)8PcH2 were able to pass 4000-hour weathering test (SAE J1960).

As an example: 5 g of 0.8% phthalocyanine dye toluene solution was mixed with 5 g of PPG DBC500 paint. The resulting paint was sprayed onto a 2″×2″ stainless steel substrate that was precoated with medium aluminum 811J. A PPG clear coat was then sprayed onto DBC500 coating. The thermally cured sample was placed in an Atlas Ci5000 Weather-Ometer and tested using SAE J1960 test method. After 4000 hours, the color difference ΔE for both samples ((beta-t-BuPh)4PcCu and (beta-S-iPr)8PcH2) was smaller than 3, indicating that these two dyes pass the 4000-hour weathering test.

The phthalocyanine dye can be substituted at one or more of the alpha hydrogen or the beta hydrogen with a bulky substituent in order to sterically hinder intermolecular packing and alignment. A bulky-substituted phthalocyanine dye is less likely to aggregate with other phthalocyanine dyes in solvent and/or polymeric host systems. For example, a phthalocyanine dye with 2-ethylhexyloxy substituents in alpha positions showed similar absorption spectrum in chloroform solution, DBC500 (a color blender manufactured by PPG Industries, Inc.), and Axalta 150K (a chroma base manufactured by Axalta Coating Systems, Ltd.), indicating the phthalocyanine dye existed in a non-aggregated form. Non-limiting examples of a bulky substituent include tert-butyl, 2-ethylhexyl, and 2-ethylhexyloxy.

In an aspect, the phthalocyanine dye can be substituted at one or more of the alpha hydrogen or the beta hydrogen with a long hydrocarbon substituent in order to increase solubility of the compound in organic solvents and/or polymeric host systems. For example, a phthalocyanine dye with 2-ethylhexyloxy substituents in alpha positions showed increased solubility in solvents, such as toluene and butyl acetate in systems, such as DBC500 (a color blender manufactured by PPG Industries, Inc.), and Axalta 150K (a chroma base manufactured by Axalta Coating Systems, Ltd.), when compared to a non-substituted phthalocyanine dye. For example, 40 mg of a 2-ethylhexyloxy-substituted phthalocyanine (2-EtHxO)8PcCu can be completely dissolved into 5 g of toluene while its non-substituted phthalocyanine PcCu is virtually insoluble in toluene. Non-limiting examples of a long hydrocarbon substituent include isopropyl, butyl, 2-ethylhexyl, and 2-ethylhexyloxy.

The article can include a reflector layer, a magnetic layer, a selective light modulator layer, a dielectric stack, and an absorber layer. The article can be symmetrical with the same number of layers on either side of a single layer, such as the reflector layer; or the same type of layers on either side of a single layer. The article can be asymmetric with different numbers of layers on either side of a single layer, such as a reflector layer; or different types of layers on either side of single layer. The article can include a single layer that is encapsulated by one or more layers. The article can include one or more open sides so that one or more of the layers discussed above are exposed to the air and/or light.

The article, such as an optical device, can include a selective light modulator layer having at least one phthalocyanine dye. The first selective light modulator layer can be present on a first surface of a reflector layer. If multiple selective light modulator layers are present, each layer can have the same or different color. For example, a first selective light modulator layer can be a color red, and a second selective light modulator layer can be blue.

The article disclosed herein can include a selective light modulator layer (SLML). The SLML is a physical layer comprising a plurality of optical functions aiming at modulating (absorbing and or emitting) light intensity in different, selected regions of spectrum of electromagnetic radiation with wavelengths ranging from about 0.2 μm to about 20 μm. The SLML can selectively modulate light by means of absorption provided by a selective light modulator system (SLMS) (discussed in more detail below). In particular, the article can include a SLML that selectively absorbs specific wavelengths of energy, such as light.

A SLML (and/or the materials within the SLML) can selectively modulate light. For example, an SLML can control the amount of transmission in specific wavelengths. In some examples, the SLML can selectively absorb specific wavelengths of energy (e.g., in the visible and/or non-visible ranges). For example, the SLML can be a “colored layer” and/or a “wavelength selective absorbing layer.” In some examples, the specific wavelengths absorbed can cause the article to appear a specific color. For example, the SLML can appear red to the human eye (e.g., the SLML can absorb wavelengths of light below approximately 620 nm and thus reflect or transmit wavelengths of energy that appear red). This can be accomplished by adding selective light modulator particles (SLMP) that are colorants (e.g., organic and/or inorganic pigments and/or dyes, such as the phthalocyanine dye) to a host material, such as a dielectric material, including but not limited to a polymer. For example, in some instances, the SLML can be a colored plastic.

In some examples, some or all of the specific wavelengths absorbed can be in the visible range (e.g., the SLML can be absorbing throughout the visible, but transparent in the infrared). The resulting article would appear black, but reflect light in the infrared. In some examples described above, the wavelengths absorbed (and/or the specific visible color) of the article and/or SLML can depend, at least in part, on the thickness of the SLML. Additionally, or alternatively, the wavelengths of energy absorbed by the SLML (and/or the color in which these layers and/or the flake appears) can depend in part on the addition of certain aspects to the SLML. In addition to absorbing certain wavelengths of energy, the SLML can achieve at least one of bolstering a reflector layer against degradation; enabling release from a substrate; enabling sizing; providing some resistance to environmental degradation, such as oxidation of aluminum or other metals and materials used in a reflector layer; and high performance in transmission, reflection, and absorption of light based upon the composition and thickness of the SLML.

In some examples, in addition to or as an alternative to the SLML selectively absorbing specific wavelengths of energy and/or wavelengths of visible light, the SLML of the article can control the refractive index and/or the SLML can include selective light modulator particles (SLMPs) that can control refractive index. SLMPs that can control the refractive index of the SLML can be included with the host material in addition to or as an alternative to an absorption controlling SLMPs (e.g., colorants). In some examples, the host material can be combined with both absorption controlling SLMPs and refractive index SLMPs in the SLML. In some examples, the same SLMP can control both absorption and refractive index.

The performance of the SLML can be determined based upon the selection of materials present in the SLML. In an aspect, the SLML can improve at least one of the following properties: flake handling, corrosion, alignment, and environmental performance of any other layers within article.

The SLML (including each SLML present in an article, if multiple layers are present) can each independently comprise a host material alone, or a host material combined with a selective light modulator system (SLMS). In an aspect, at least one of the first SLML can include a host material. In another aspect, at least one of the first SLML can include a host material and a SLMS. The SLMS can include a selective light modulator molecule (SLMM), a selective light modulator particle (SLMP), an additive, or combinations thereof.

The composition of the SLML can have a solids content ranging from about 0.01% to about 100%, for example from about 0.05% to about 80%, and as a further example from about 1% to about 30%. In some aspects, the solids content can be greater than 3%. In some aspects, the composition of the SLML can have a solids content ranging from about 3% to about 100%, for example from about 4% to 50%.

The host material of the first SLML can independently be a film forming material applied as a coating liquid and serving optical and structural purposes. The host material can be used as a host (matrix) for introducing, if necessary, a guest system, such as the selective light modulator system (SLMS), for providing additional light modulator properties to the article.

The host material can be a dielectric material. Additionally, or alternatively, the host material can be at least one of an organic polymer, an inorganic polymer, and a composite material. Non-limiting examples of the organic polymer include thermoplastics, such as polyesters, polyolefins, polycarbonates, polyamides, polyimides, polyurethanes, acrylics, acrylates, polyvinylesters, polyethers, polythiols, silicones, fluorocarbons, and various co-polymers thereof; thermosets, such as epoxies, polyurethanes, acrylates, melamine formaldehyde, urea formaldehyde, and phenol formaldehyde; and energy curable materials, such as acrylates, epoxies, vinyls, vinyl esters, styrenes, and silanes. Non-limiting examples of inorganic polymers includes silanes, siloxanes, titanates, zirconates, aluminates, silicates, phosphazanes, polyborazylenes, and polythiazyls.

The first SLML can include from about 0.001% to about 100% by weight of a host material. In an aspect, the host material can be present in the SLML in an amount ranging from about 0.01% to about 95% by weight, for example from about 0.1% to about 90%, and as a further example from about 1% to about 87% by weight of the SLML.

The SLMS, for use in the SLML with the host material, can each independently comprise selective light modulator particles (SLMP), selective light modulator molecules (SLMM), additives, or a combination thereof. The SLMS can also comprise other materials. The SLMS can provide modulation of the amplitude of electromagnetic radiation (by absorption, reflectance, fluorescence etc.) in a selective region or the entire spectral range of interest (0.2 μm to 20 μm).

The first SLML can each independently include in an SLMS a SLMP. The SLMP can be any particle combined with the host material to selectively control light modulation, including, but not limited to color shifting particles, dyes, colorants include colorant includes one or more of dyes (such as the phthalocyanine dye discussed above), pigments, reflective pigments, color shifting pigments, quantum dots, and selective reflectors. Non-limiting examples of a SLMP include: organic pigments, inorganic pigments, quantum dots, nanoparticles (selectively reflecting and/or absorbing), micelles, etc. The nanoparticles can include, but are not limited to organic and metalorganic materials having a high value of refractive index (n>1.6 at wavelength of about 550 nm); metal oxides, such as TiO₂, ZrO₂, In₂O₃, In₂O₃—SnO, SnO₂, FeOₓO_{y} (wherein x and y are each independently integers greater than 0), and WO₃; metal sulfides, such as ZnS, and CuₓS_{y} (wherein x and y are each independently integers greater than 0); chalcogenides, quantum dots, metal nanoparticles; carbonates; fluorides; and mixtures thereof.

Examples of a SLMM include but are not limited to: organic dyes, inorganic dyes, micelles, and other molecular systems containing a chromophore. The SLMM can be a phthalocyanine dye as discussed above.

In some aspects, SLMS of the first SLML can include at least one additive, such as a curing agent, and a coating aid.

The curing agent can be a compound or material that can initiate hardening, vitrification, crosslinking, or polymerizing of the host material. Non-limiting examples of a curing agent include solvents, radical generators (by energy or chemical), acid generators (by energy or chemical), condensation initiators, and acid/base catalysts.

Non-limiting examples of the coating aid include leveling agents, wetting agents, defoamers, adhesion promoters, antioxidants, UV stabilizers, curing inhibition mitigating agents, antifouling agents, corrosion inhibitors, photosensitizers, secondary crosslinkers, and infrared absorbers for enhanced infrared drying. In an aspect, the antioxidant can be present in the composition of the SLML in an amount ranging from about 25 ppm to about 5% by weight.

The first SLML can each independently comprise a solvent. Non-limiting examples of solvents can include acetates, such as ethyl acetate, propyl acetate, and butyl acetate; acetone; water; ketones, such as dimethyl ketone (DMK), methylethyl ketone (MEK), secbutyl methyl ketone (SBMK), ter-butyl methyl ketone (TBMK), cyclopenthanon, and anisole; glycol and glycol derivatives, such as propylene glycol methyl ether, and propylene glycol methyl ether acetate; alcohols, such as isopropyl alcohol, and diacetone alcohol; esters, such as malonates; heterocyclic solvents, such as n-methyl pyrrolidone; hydrocarbons, such as toluene, and xylene; coalescing solvents, such as glycol ethers; and mixtures thereof. In an aspect, the solvent can be present in the first SLML in an amount ranging from about 0% to about 99.9%, for example from about 0.005% to about 99%, and as a further example from about 0.05% to about 90% by weight relative to the total weight of the SLML.

In some examples, the first SLML can include a composition having at least one of (i) a photoinitiator, (ii) an oxygen inhibition mitigation composition, (iii) a leveling agent, and (iv) a defoamer.

The oxygen inhibition mitigation composition can be used to mitigate the oxygen inhibition of the free radical material. The molecular oxygen can quench the triplet state of a photoinitiator sensitizer or it can scavenge the free radicals resulting in reduced coating properties and/or uncured liquid surfaces. The oxygen inhibition mitigation composition can reduce the oxygen inhibition or can improve the cure of any SLML.

The oxygen inhibition composition can comprise more than one compound. The oxygen inhibition mitigation composition can comprise at least one acrylate, for example at least one acrylate monomer and at least one acrylate oligomer. In an aspect, the oxygen inhibition mitigation composition can comprise at least one acrylate monomer and two acrylate oligomers. Non-limiting examples of an acrylate for use in the oxygen inhibition mitigation composition can include acrylates; methacrylates; epoxy acrylates, such as modified epoxy acrylate; polyester acrylates, such as acid functional polyester acrylates, tetra functional polyester acrylates, modified polyester acrylates, and bio-sourced polyester acrylates; polyether acrylates, such as amine modified polyether acrylates including amine functional acrylate co-initiators and tertiary amine co-initiators; urethane acrylates, such aromatic urethane acrylates, modified aliphatic urethane acrylates, aliphatic urethane acrylates, and aliphatic allophanate based urethane acrylates; and monomers and oligomers thereof. In an aspect, the oxygen inhibition mitigation composition can include at least one acrylate oligomer, such as two oligomers. The at least one acrylate oligomer can be selected/chosen from a polyester acrylate and a polyether acrylate, such as a mercapto modified polyester acrylate and an amine modified polyether tetraacrylate. The oxygen inhibition mitigation composition can also include at least one monomer, such as 1,6-hexanediol diacrylate. The oxygen inhibition mitigation composition can be present in the first SLML in an amount ranging from about 5% to about 95%, for example from about 10% to about 90%, and as a further example from about 15% to about 85% by weight relative to the total weight of the SLML.

In some examples, the host material of the SLML can use a non-radical cure system such as a cationic system. Cationic systems are less susceptible to the mitigation of the oxygen inhibition of the free radical process, and thus may not require an oxygen inhibition mitigation composition. In an example, the use of the monomer 3-ethyl-3-hydroxymethyloxetane does not require an oxygen mitigation composition.

In an aspect, the first SLML can each independently include at least one photoinitiator, such as two photoinitiators, or three photoinitiators. The photoinitiator can be used for shorter wavelengths. The photoinitiator can be active for actinic wavelength. The photoinitiator can be a Type 1 photoinitiator or a Type II photoinitiator. The SLML can include only Type I photoinitiators, only Type II photoinitiators, or a combination of both Type I and Type II photoinitiators. The photoinitiator can be present in the composition of the SLML in an amount ranging from about 0.25% to about 15%, for example from about 0.5% to about 10%, and as a further example from about 1% to about 5% by weight relative to the total weight of the composition of the SLML.

The photoinitiator can be a phosphineoxide. The phosphineoxide can include, but is not limited to, a monoacyl phosphineoxide and a bis acyl phosphine oxide. The mono acyl phosphine oxide can be a diphenyl (2,4,6-trimethylbenzoyl)phosphineoxide. The bis acyl phosphine oxide can be a bis (2,4,6-trimethylbenzoyl)phenylphosphineoxide. In an aspect, at least one phosphineoxide can be present in the composition of the SLML. For example, two phosphineoxides can be present in the composition of the SLM.

A sensitizer can be present in the composition of the SLML and can act as a sensitizer for Type 1 and/or a Type II photoinitiators. The sensitizer can also act as a Type II photoinitiator. In an aspect, the sensitizer can be present in the composition of the SLML in an amount ranging from about 0.05% to about 10%, for example from about 0.1% to about 7%, and as a further example from about 1% to about 5% by weight relative to the total weight of the composition of the SLML. The sensitizer can be a thioxanthone, such as 1-chloro-4-propoxythioxanthone.

In an aspect, the SLML can include a leveling agent. The leveling agent can be a polyacrylate. The leveling agent can eliminate cratering of the composition of the SLML. The leveling agent can be present in the composition of the SLML in an amount ranging from about 0.05% to about 10%, for example from about 1% to about 7%, and as a further example from about 2% to about 5% by weight relative to the total weight of the composition of the SLML.

The first SLML can also include a defoamer. The defoamer can reduce surface tension. The defoamer can be a silicone free liquid organic polymer. The defoamer can be present in the composition of the SLML in an amount ranging from about 0.05% to about 5%, for example from about 0.2% to about 4%, and as a further example from about 0.4% to about 3% by weight relative to the total weight of the composition of the SLML.

The first SLML can each independently have a refractive index of greater or less than about 1.5. For example, each SLML can have a refractive index of approximately 1.5. The refractive index of each SLML can be selected to provide a degree of color travel required wherein color travel can be defined as the change in hue angle measured in L*a*b* color space with the viewing angle. In some examples, each SLML can include a refractive index in a range of from about 1.1 to about 3.0, about 1.0 to about 1.3, or about 1.1 to about 1.2. In some examples, the refractive index of each SLML can be less than about 1.5, less than about 1.3, or less than about 1.2. In some examples, SLML can have substantially equal refractive indexes or different refractive indexes one from the other, if more than one SLML is present in the article.

The SLML can have a thickness ranging from about 1 nm to about 10000 nm, about 10 nm to about 1000 nm, about 20 nm to about 500 nm, about 1 nm, to about 100 nm, about 10 nm to about 1000 nm, about 1 nm to about 5000 nm. In an aspect, the article, such as an optical device, can have an aspect ratio of 1:1 to 1:50 thickness to width.

One of the benefits of the article described herein, however, is that, in some examples, the optical effects appear relatively insensitive to thickness variations. Thus, in some aspects, each SLML can independently have a variation in optical thickness of less than about 5%. In an aspect, each SLML can independently include an optical thickness variation of less than about 3% across the layer. In an aspect, each SLML can independently have less than about 1% variation in optical thickness across the layer having a thickness of about 50 nm.

In an aspect, the article, such as an optical device in the form of a flake, foil or sheet, can also include a substrate and/or a release layer. In an aspect, the release layer can be disposed between a substrate and the article. The substrate can be made of a flexible material. The substrate can be any suitable material that can receive layers deposited during the manufacturing process. Non-limiting examples of suitable substrate materials include polymer web, such as polyethylene terephthalate (PET), glass foil, glass sheets, polymeric foils, polymeric sheets, metal foils, metal sheets, ceramic foils, ceramic sheets, ionic liquid, paper, silicon wafers, etc. The substrate can vary in thickness, but can range for example from about 2 μm to about 100 μm, and as a further example from about 10 to about 50 μm.

Additionally, or alternatively, the article in the form of a flake, sheet, or foil can also include a hard coat or protective layer on the article. In some examples, these layers (hard coat or protective layer) do not require optical qualities.

The article, such as optical devices, described herein can be made in any way. For example, a sheet can be made and then divided, broken, ground, etc. into smaller pieces forming an optical device. In some examples, the sheet can be created by a liquid coating process, including, but not limited to the processes described below.

There is disclosed a method for manufacturing an article, for example in the form of a sheet, flake, or foil, as described herein. The method can include depositing layers onto the substrate to form an article, wherein each layer is applied on top of previously deposited layers. The deposited layers can include one or more of the following layers in any order: a reflector layer, a magnetic layer, a selective light modulator layer, a dielectric stack, and an absorber layer.

The method can comprise depositing on a substrate a reflector layer; and depositing a selective light modulator layer onto the reflector layer using a liquid coating process. The selective light modulator layer can be a first selective light modulator layer, and the method can further include depositing a second selective light modulator layer between the substrate and the reflector layer. In the disclosed methods, the reflector layer can be deposited using known conventional deposition process, such as physical vapor deposition, chemical vapor deposition, thin-film deposition, atomic layer deposition, etc., including modified techniques such as plasma enhanced and fluidized bed.

The SLML can be deposited by a liquid coating process, such as a slot die process. The liquid coating process can include, but is not limited to: slot-bead bead, slide bead, slot curtain, slide curtain, in single and multilayer coating, tensioned web slot, gravure, roll coating, and other liquid coating and printing processes that apply a liquid on to a substrate or previously deposited layer to form a liquid layer or film that is subsequently dried and/or cured.

The substrate can be released from the deposited layers (including, but not limited to a reflector layer, and a first SLML) to create the article. In an aspect, the substrate can be cooled to embrittle an associated release layer, if present. In another aspect, the release layer could be embrittled for example by heating and/or curing with photonic or e-beam energy, to increase the degree of cross-linking, which would enable stripping. The deposited layers can then be stripped mechanically, such as sharp bending or brushing of the surface. The released and stripped layers can be sized into article, such as an optical device in the form of a flake, foil, or sheet, using known techniques.

In another aspect, the deposited layers can be transferred from the substrate to another surface. The deposited layers can be punched or cut to produce large flakes with well-defined sizes and shapes.

The liquid coating process can allow for the transfer of the composition of the SLML at a faster rate as compared to other deposition techniques, such as vapor deposition. Additionally, the liquid coating process can allow for a wider variety of materials to be used in the SLML with a simple equipment set up. It is believed that the SLML formed using the disclosed liquid coating process can exhibit improved optical performance.

A liquid coating process can include inserting into a slot die a composition of a layer, e.g. SLML (a liquid coating composition) and depositing the composition on a substrate resulting in a wet film. With reference to the processes disclosed above, the substrate can include at least one of a substrate, a release layer, a reflector layer, and previously deposited layers. The distance from the bottom of the slot die to the substrate is the slot gap G. The liquid coating composition can be deposited at a wet film thickness D that is greater than a dry film thickness H. After the wet film of the liquid coating composition has been deposited on the substrate, any solvent present in the wet film of the liquid coating composition can be evaporated. The liquid coating process continues with curing of the wet film of the liquid coating composition to result in a cured, self-leveled layer having the correct optical thickness H (ranging from about 30 to about 700 nm). It is believed that the ability of the liquid coating composition to self-level results in a layer having a reduced optical thickness variation across the layer. Ultimately, an article, such as an optical device, comprising the self-leveled liquid coating composition can exhibit increased optical precision. For ease of understanding, the terms “wet film” and “dry film” will be used to refer to the liquid coating composition at various stages of the liquid coating process.

The liquid coating process can comprise adjusting at least one of a coating speed and a slot gap G to achieve a wet film with a predetermined thickness D. The liquid coating composition can be deposited having a wet film thickness D ranging from about 0.1 μm to about 500 μm, for example from about 0.1 μm to about 5 μm. The liquid coating composition formed with a wet film thickness D in the disclosed range can result in a stable SLML layer, such as a dielectric layer, i.e., without breaks or defects such as ribbing or streaks. In an aspect, the wet film can have a thickness of about 10 μm for a stable wet film using a slot die bead mode with a coating speed up to about 100 m/min. In another aspect, the wet film can have a thickness of about 6-7 μm for a stable wet film using a slot die curtain mode with a coating speed up to about 1200 m/min.

The liquid coating process can include a ratio of slot gap G to wet film thickness D of about 1 to about 100 at speeds from about 0.1 to about 1000 m/min. In an aspect, the ratio is about 9 at a coating speed of about 100 m/min. In an aspect, the ratio can be about 20 at a coating speed of about 50 m/min. The liquid coating process can have a slot gap G ranging from about 0 to about 1000 μm. A smaller slot gap G can allow for a reduced wet film thickness. In slot-bead mode higher coating speeds can be achieved with a wet film thickness greater than 10 μm.

The liquid coating process can have a coating speed ranging from about 0.1 to about 1000 m/min, for example from about 25 m/min to about 950 m/min, for example from about 100 m/min to about 900 m/min, and as a further example from about 200 m/min to about 850 m/min. In an aspect, the coating speed is greater than about 150 m/min, and in a further example is greater than about 500 m/min.

In an aspect, the coating speed for a bead mode liquid coating process can range from about 0.1 m/min to about 600 m/min, and for example from about 50 to about 150 m/min. In another aspect, the coating speed for a curtain mode liquid coating process can range from about 200 m/min to about 1500 m/min, and for example, from about 300 m/min to about 1200 m/min.

The solvent can be evaporated from the wet film, such as before the wet film is cured. In an aspect, about 100%, for example about 99.9%, and as a further example about 99.8% of the solvent can be evaporated from the liquid coating composition prior to curing of the liquid coating composition. In a further aspect, trace amounts of solvent can be present in a cured/dry liquid coating composition. In an aspect, a wet film having a greater original weight percent of solvent can result in a dry film having a reduced film thickness H. In particular, a wet film having a high weight percent of solvent and being deposited at a high wet film thickness D can result in a liquid coating composition, such as the SLML having a low dry film thickness H. It is important to note, that after evaporation of the solvent, the wet film remains a liquid thereby avoiding problems such as skinning, and island formation during the subsequent curing steps in the liquid coating process.

The dynamic viscosity of the wet film can range from about 0.5 to about 50 cP, for example from about 1 to about 45 cP, and as a further example from about 2 to about 40 cP. The viscosity measurement temperature is 25° C., the rheology was measured with an Anton Paar MCR 101 rheometer equipped with a solvent trap using a cone/plate 40 mm diameter with 0.3° angle at a gap setting of 0.025 mm.

In an aspect, the liquid coating composition and the solvent can be selected so that the wet film exhibits Newtonian behavior for precision coating of the liquid coating composition using the liquid coating process. The wet film can exhibit Newtonian behavior shear rates up to 10,000 s⁻¹ and higher. In an aspect, the shear rate for the liquid coating process can be 1000 s⁻¹ for a coating speed up to 25 m/min, for example 3900 s⁻¹ for a coating speed up to 100 m/min, and as a further example 7900 s⁻¹ for a coating speed up to 200 m/min. It will be understood that a maximum shear rate can occur on a very thin wet film, such as 1 μm thick.

As the wet film thickness is increased, the shear rate can be expected to decrease, for example decrease 15% for a 10 μm wet film, and as a further example decrease 30% for a 20 μm wet film.

The evaporation of the solvent from the wet film can cause a change in viscosity behavior to pseudoplastic, which can be beneficial to achieve a precision SLML. The dynamic viscosity of the deposited SLML after any solvent has been evaporated, can range from about 10 cP to about 3000 cP, for example from about 20 cP to about 2500 cP, and as a further example from about 30 cP to about 2000 cP. When evaporating the solvent, if present, from the wet film there can be an increase in viscosity to the pseudoplastic behavior. The pseudoplastic behavior can allow for self-leveling of the wet film.

In an aspect, the method can include evaporating the solvent present in the wet film using known techniques. The amount of time required to evaporate the solvent can be dependent upon the speed of the web/substrate and the dryer capacity. In an aspect, the temperature of the dryer (not shown) can be less than about 120° C., for example less than about 100° C., and as a further example less than about 80° C.

The wet film deposited using a liquid coating process can be cured using known techniques. In an aspect, the wet film can be cured using a curing agent utilizing at least one of an ultraviolet light, visible light, infrared, or electron beam. Curing can proceed in an inert or ambient atmosphere. In an aspect, the curing step utilizes an ultraviolet light source having a wavelength of about 395 nm. The ultraviolet light source can be applied to the wet film at a dose ranging from about 200 mJ/cm² to about 1000 mJ/cm², for example ranging from about 250 mJ/cm² to about 900 mJ/cm², and as a further example from about mJ/cm² to about 850 mJ/cm².

The wet film can crosslink by known techniques. Non-limiting examples include photoinduced polymerization, such as free radical polymerization, spectrally sensitized photoinduced free radical polymerization, photoinduced cationic polymerization, spectrally sensitized photoinduced cationic polymerization, and photoinduced cycloaddition; electron beam induced polymerization, such as electron beam induced free radical polymerization, electron beam induced cationic polymerization, and electron beam induced cycloaddition; and thermally induced polymerization, such as thermally induced cationic polymerization.

A SLML formed using the liquid coating process can exhibit improved optical performance, i.e., be a precision SLML. In some examples, a precision SLML can be understood to mean a SLML having less than about 3% optical thickness variation, about 5% optical thickness variation, or about 7% optical thickness variation across the layer.

In an aspect, the liquid coating process can include adjusting at least one of speed from about 5 to about 100 m/min and a coating gap from about 50 μm to about 100 μm to deposit a wet film from about 2 μm to 10 μm of the selective light modulator layer with a predetermined thickness from about 500 nm to about 1500 nm. In a further aspect, the process can include a speed of 30m/min, a 75 um gap, 10 um wet film, dry film thickness 1.25 um.

From the foregoing description, those skilled in the art can appreciate that the present teachings can be implemented in a variety of forms. Therefore, while these teachings have been described in connection with particular embodiments and examples thereof, the true scope of the present teachings should not be so limited. Various changes and modifications can be made without departing from the scope of the teachings herein.

This scope disclosure is to be broadly construed. It is intended that this disclosure disclose equivalents, means, systems and methods to achieve the devices, activities and mechanical actions disclosed herein. For each device, article, method, mean, mechanical element or mechanism disclosed, it is intended that this disclosure also encompass in its disclosure and teaches equivalents, means, systems and methods for practicing the many aspects, mechanisms and devices disclosed herein. Additionally, this disclosure regards a coating and its many aspects, features and elements. Such a device can be dynamic in its use and operation, this disclosure is intended to encompass the equivalents, means, systems and methods of the use of the device and/or optical device of manufacture and its many aspects consistent with the description and spirit of the operations and functions disclosed herein. The claims of this application are likewise to be broadly construed. The description of the inventions herein in their many embodiments is merely exemplary in nature and, thus, variations that do not depart from the gist of the invention are intended to be within the scope of the invention. Such variations are not to be regarded as a departure from the spirit and scope of the invention.

1-20. (canceled)

21. An article, comprising:
a selective light modulator layer includes a host material, and a selective light modulator particle;
wherein the selective light modulator particle is a phthalocyanine dye having substituents that provide a bathochromic shift or a hypsochromic shift in the absorption spectrum.

22. The article of claim 21, wherein the article is an optical device in a form of a foil or a flake; and
wherein the host material is at least one of an organic polymer, an inorganic polymer, a dielectric material, and an organic solvent.

23. The article of claim 21, wherein the phthalocyanine dye is substituted at one or more alpha hydrogen or beta hydrogen with a hydrocarbon substituent;
wherein the hydrocarbon substituent is chosen from isopropyl, butyl, 2-ethylhexyl, and 2-ethylhexyloxy; and
wherein the phthalocyanine dye is soluble in the host material.

24. The article of claim 21, wherein the phthalocyanine dye is substituted at one or more alpha hydrogen or beta hydrogen with a branched substituent;
wherein the branched substituent is chosen from tert-butyl, 2-ethylhexyl, and 2-ethylhexyloxy; and
wherein the phthalocyanine dye does not aggregate.

25. The article of claim 21, wherein the phthalocyanine dye has at least one alpha substituent selected from the group consisting of alkoxy (2-ethylhexyloxy), alkyl (isopropyl, butyl, t-butyl, 2-ethylhexyl), aryl, and thioether.

26. The article of claim 21, wherein the phthalocyanine dye has at least one beta substituent selected from the group consisting of alkoxy, alkyl, aryl, and thioether.

27. The article of claim 21, wherein the phthalocyanine dye has a central metal ion.

28. The article of claim 27, wherein the central metal ion is a paramagnetic ion selected from the group consisting of Cu(II), Co(II), V(IV)O, Mn(III), and Mo(IV)O.

29. The article of claim 21, wherein the phthalocyanine dye is chosen from alpha-butoxy phthalocyanine with a V(IV)O central metal ion, alpha-butoxy phthalocyanine with a Mn(III) central metal ion, alpha-butoxy substituted phthalocyanine, beta-isopropylmercapto substituted phthalocyanine, (beta-t-BuPh)4PcCu, (beta-S-iPr)8PcH₂, and (2-EtHxO)8PcCu.

30. The article of claim 27, wherein the phthalocyanine dye has an off-plane ligand to the central metal ion.

31. The article of claim 30, wherein the off-plane ligand is selected from the group consisting of acyloxy and alkoxy groups.

32. The article of claim 21, wherein the phthalocyanine dye has a central non-metal element.

33. The article of claim 21, further comprising at least one layer chosen from a reflector layer, a magnetic layer, a dielectric stack, a second selective light modulator layer, and an absorber layer.

34. The article of claim 21, wherein the selective light modulator layer has a thickness ranging from about 1 nm to about 10000 nm.

35. The article of claim 21, wherein the substituent that provides a bathochromic shift is an electron-donating group.

36. The article of claim 35, wherein the electron-donating group is selected from the group consisting of alkyl, aryl, alkoxy, aryloxy, OH, amides, esters, and thiols.

37. The article of claim 35, wherein the electron-donating group includes a substituent chosen from methyl, methoxy, isopropyloxy, tert-butoxy, phenyl, biphenyl, acetyloxy, isopropylmercapto, phenylmercapto, and acetamino.

38. The article of claim 21, wherein the substituent that provides a hypsochromic shift is an electron-withdrawing group.

39. The article of claim 38, wherein the electron-withdrawing group is a substituent chosen from pyrazine, fluoro, nitro, fluoroalkyl, organic ammonium, pyridinium, sulfonyl, cyano, and carbonyl —C(O)R′ wherein R′ is an alkyl or aryl, and ester —C(O)OR″ wherein R″ is an alkyl, aryl, and the like.

40. The article of claim 21, wherein the phthalocyanine dye is present in the selective light modulator layer in an amount ranging from about 5×10⁻⁴ mol/l to about 10 mol/l.
